(19) United States
(12) Patent Application Publication
(10) Pub. No.: US 2011/0210955 A1
(43) Pub. Date: Sep. 1, 2011

(54) GATE DRIVER AND RELATED DRIVING METHOD FOR LIQUID CRYSTAL DISPLAY

(76) Inventors: Chih-Yuan Chang, Changhua County (TW); Yen-Hong Lin, Changhua County (TW)

(21) Appl. No.: 12/782,718

(22) Filed: May 19, 2010

(30) Foreign Application Priority Data
Mar. 1, 2010 (TW) 099105871

(51) Int. Cl. G06F 3/038; G09G 3/36

(52) U.S. Cl. 345/212; 345/100

(57) ABSTRACT

The invention provides a gate driver for a liquid crystal display. The gate driver includes a first shift register for sequentially generating a plurality of first scan signals according to a synchronization start signal and a clock signal, an enable control unit for generating an enable signal according to the plurality of first scan signals, a second shift register for generating a plurality of second scan signals sequentially according to the synchronization start signal, the clock signal, and the enable signal, a level shifter for generating a plurality of first output signals and a plurality of second output signals, a logic processing unit for selectively perform logic on the plurality of first output signals and the plurality of second output signals to generate a plurality of gate driving signals, and an output stage for outputting the plurality of gate driving signals.

### BACKGROUND OF THE INVENTION

1. Field of the Invention

The present invention relates to a gate driver and related driving method for a liquid crystal display, and more particularly, to a gate driver and related driving method capable of reducing high voltage circuit area.

2. Description of the Prior Art

A liquid crystal display (LCD) offers advantages of thin construction, low power consumption, and low radiation, so that the LCD is widely applied in various electronic products, such as LCD televisions, computer systems, mobile phones, and personal digital assistants. The liquid crystal display operates by varying voltage drops between opposite sides of a liquid crystal layer for twisting liquid crystal molecules in the liquid crystal layer to alter transmittance of the liquid crystal layer, which can be controlled to produce images with the aid of light provided by a backlight module.

A typical LCD device includes an LCD panel and a driving circuit. The LCD panel includes a plurality of pixel units for displaying images. The driving circuit includes a timing controller, a gate driver, and a source driver. The gate driver is utilized for driving switches of each pixel unit to control a writing operation of the source driver for displaying desired images. The source driver is utilized for providing data signals to be written into the pixel units for required image display. The timing controller is utilized for providing corresponding control signals and data signals to the gate driver and the source driver for controlling the whole image display process.

In general, the gate driver can generate the corresponding gate driving signal to control the switches of each pixel unit of the LCD panel. For instance, please refer to FIG. 1, which is a schematic diagram of a gate driver 10 according to the prior art. The gate driver 10 includes a shift register 102, a logic control unit 104, a level shifter 106, and an output stage 108. The shift register 102 is utilized for generating scan signals Q1 to Qn sequentially according to a synchronization start signal STV and a clock signal CLK. The logic control unit 104 is coupled to the shift register 102 for generating logic control signals X1 to Xn according to an output enabled signal OE and a global on indication signal XON. The synchronization start signal STV, the clock signal CLK, the output enabled signal OE, and the global on indication signal XON can be provide by a timing controller. The global on indication signal XON is utilized for reducing motion blur through conducting transistors of each scan line during a system power on or power off operation. In addition, the output enabled signal OE is utilized for making the gate driver stop outputting signals during a specific period in order to avoid an overlap problem caused by outputting two scan lines simultaneously due to RC delay. In practical application, one or more output enabled signals can be utilized for solving the output overlap problem. Thus, the logic control unit 104 can perform related processes on the required image for resolving related image display problems according to a corresponding control signal, such as the output enabled signal OE, the global on indication signal XON, etc. The level shifter 106 is coupled to the logic control unit 104 for generating gate driving signals G1′ to Gn′ according to the logic control signals X1 to Xn, a gate-on voltage VGH, and a gate-off voltage VGL. The gate-on voltage VGH and the gate-off voltage VGL are provided by a timing controller. In addition, the level shifter 106 is well known by those skilled in the art, and the details of its operation principle are not further explained herein for the sake of brevity. The output stage 108 is coupled to the level shifter 106 and scan lines S1 to Sn (not shown in the FIG. 1) for outputting the gate driving signals G1 to Gn to the scan lines S1 to Sn for driving the pixel units corresponding to the scan lines.

For brevity of description, suppose number of output channels of the gate driver 10 is 240 (i.e. n=240), and the signal waveforms of each component of the gate driver 10 are shown in FIG. 2. In such a condition, the gate driver can provide the gate driving signals G1 to G240 for controlling the pixel units coupled to the scan lines S1 to 5240. The shift register 102 includes shift register units R1 to R240. Furthermore, suppose the shift register 102 operates with a single start pulse driving method and a clock rising edge triggering scheme. Therefore, after the first shift register unit R1 of the shift register 102 receives the synchronization start signal STV, the first shift register unit R1 is triggered on the rising edge of the clock signal CLK to generate a scan signal Q1 transmitted to the logic control unit 104. Moreover, the scan signal Q1 (low voltage signal) can be transformed to the gate driving signal G1 (high voltage signal) to drive the pixel unit on the scan line S1 after the processing of the logic control unit 104, the level shifter 106, and the output stage 108. Besides, when the first shift register unit R1 transmits the scan signals Q1 to the next stage (the shift register unit R2), the shift register unit R1 also delivers the scan signal Q1 to the logic control unit 104 simultaneously. Similarly, the shift register unit R2 can be triggered on the rising edge of the clock signal CLK to generate the scan signal Q2 after receiving the scan signals Q1. Thus, the scan signal Q2 can be transmitted to the logic control unit 104 and the next shift register unit (shift register unit R3) simultaneously, and the gate driver 10 is able to generate the gate driving signal G2 accordingly. In such manner, the gate driver 10 is capable of sequentially generating gate driving signals G1 to G240.

In practice, the gate driver 10 is operated according to a one-by-one scheme, which means that for each gate driving signal, there is one corresponding circuit block in the shift register 102, the logic control unit 104, the level shifter 106, and the output stage 108 in order to generate the gate driving signal. In such a condition, the long start pulse driving method or dual start pulse driving method can be applied suitably to the gate driver 10 to drive the shift register 102. The dual start pulse driving method means the synchronization start signal STV will be triggered twice during a specific clock period. The long start pulse driving method means that the pulse width of a synchronization start signal STV is larger than a specific clock cycle and two or more output channels output signals at the same time. Please refer to FIG. 3 and FIG. 4. FIG. 3 and FIG. 4 are schematic diagrams of the gate driver 10 using long start pulse driving and dual start pulse driving respectively according to the prior art. As shown in FIG. 3, when the LCD needs to adjust the displayed image, such as performing a zoom in or zoom out process, the gate driver 10 can utilize the long start pulse driving method with several output enabled signals, such as output enabled signals OE1 to OE3, for image adjustment. As shown in FIG. 4, the gate driver 10 can utilize the dual start pulse driving method with several output enabled signals to implement pre-charging for the transistor of the pixel unit. In other words, the gate driver 10 can utilize the single start pulse driving, the long start pulse driving, and the dual start pulse driving method for related image processing applications.

However, regarding the circuit implementation of the gate driver 10, one low voltage circuit block (shift register 102 and logic control unit 104) and one high voltage circuit block (level shifter 106 and output stage 108) are required for generating the corresponding gate driving signal for each output channel (scan line) due to the one-by-one gate driver structure. Thus, when the gate driver 10 has 240 output channels, 240 sets of high voltage circuit blocks and 240 sets of corresponding low voltage circuit blocks are required for implementing the gate driver 10. In integrated circuit design, required circuit area of high voltage circuit components is far larger than required circuit area of low voltage circuit components. So, as the gate driver 10 has multiple output channels, the circuit area of the gate driver 10 is limited by the high voltage circuit block. Certainly, the gate driver 10 can not avoid using a large number of high voltage circuit components, such as the level shifter 106, and therefore, the circuit area of the gate driver 10 is usually very large and difficult to be reduce, thereby causing expensive manufacturing cost.

Please refer to FIG. 5, which is a schematic diagram of a gate driver 50 according to the prior art. The gate driver 50 includes a counter 502, a decoder 504, level shifters 506A and 506B, a logic processing unit 508, and an output stage 510. The counter 502 generates a count value C transmitted to the decoder 504 according to a synchronization start signal STV and a clock signal CLK. The decoder 504 is coupled to the counter 502 for generating a high decoding signal MSB and a low decoding signal LSB according to the count value, an output enable signal OE, and a global on indication signal XON. In detail, the counter 502 enabled in accordance with the clock signal CLK begins to count and generate the count value after receiving the synchronization start signal STV. Furthermore, the decoder 504 can divide the received count value into a most significant bit count value C_{M} having M bits and a least significant bit count value C_{L} having L bits, and generate the corresponding high decoding signal MSB and the low decoding signal LSB accordingly. Therefore, the corresponding high decoding signal MSB and the low decoding signal LSB can be transmitted to the level shifters 506A and 506B respectively for voltage level shifting. The level shifters 506A and 506B are coupled to the decoder 504 for generating a high driving signal MSB′ and a low driving voltage LSB′ according to the high decoding signal MSB, the low decoding signal LSB, a gate-on voltage VGH, and a gate-off voltage VGL. The logic processing unit 508 is coupled to the level shifters 506A and 506B for performing logic operations on the high driving signal MSB′ and the low driving voltage LSB′ to generate gate driving signal G1′ to Gn′. The output stage 510 is coupled to the level shifters 506A and 506B, and scan lines S1 to Sn (not shown in FIG. 5) for outputting the gate driving signals G1 to Gn to the scan lines S1 to Sn for driving the pixel units corresponding to the scan lines S1 to Sn.

Please refer to FIG. 6, which is a schematic diagram of signal waveforms of each component of the gate driver 50 shown in FIG. 5 according to the prior art. As shown in FIG. 6, suppose the gate driver 50 has 240 output channels (n=240), and a single start pulse driving method and a clock rising edge triggering scheme are adopted. The count 502 is enabled on the rising edge of the clock signal CLK and begins to count after receiving the synchronization start signal STV. After that, the counter 502 generates an eight bit count value C outputted to the decoder 504 according to the clock signal. The decoder 504 divides the received count value C into a four bit high decoding signal MSB and a four bit low decoding signal LSB (M=4, L=4). The high decoding signal MSB and the low decoding signal LSB are translated to the corresponding high voltage signals (the high driving signal MSB′ and the low driving voltage LSB′). Finally, after the processing by the logic processing unit 508 and the output stage 510, the gate driving signals G1 to G204 can be generated sequentially and outputted to scan lines S1 to 5240 for driving pixel units corresponding to the scan lines S1 to 5240.

Compared with the gate driver 10 shown in FIG. 1, the gate driver 50 having 240 output channels needs only one eight bit counter and decoder without 240 sets of shift registers in the low voltage circuit block, and needs only 31 sets of level shifters and one logic processing unit. Although the gate driver 50 includes an extra logic processing unit circuit block, the gate driver 50 can reduce the circuit layout area on a whole by one third. However, for the gate driver 50 to adopt long start pulse driving or dual start pulse driving, a complicated logic control design needs to be inserted at a front end of the gate driver 50, increasing circuit area and chip error design risk.

In short, the above-mentioned gate driver 10 has a simple structure and can be widely used in various image display enhancement processes. However, as the size of LCDs is increasing, the required number of output channels (scan lines) is increasing. In such a condition, using the scheme of the gate driver 10 may require large circuit area and high manufacturing cost. Although using the scheme of the gate driver 50 can reduce the required circuit area, the gate driver 50 can not be applied to other image display enhancement functions. Thus, with the advancement of image display techniques, as number of the output channels increases, and component sizes decrease, how to reduce the circuit area of the gate driver should be a concern in improving application design.

### SUMMARY OF THE INVENTION

It is therefore an objective of the present invention to provide a gate driver and related driving method for a liquid crystal display.

The present invention discloses a gate driver for a liquid crystal display, which the gate driver includes a first shift register, for sequentially generating a plurality of first scan signals according to a synchronization start signal and a clock signal; an enable control unit, coupled to the first shift register, for generating an enable signal according to the plurality of first scan signals; a second shift register, coupled to the enable control unit, for sequentially generating a plurality of second scan signals according to the synchronization start signal, the clock signal, and the enable signal; a level shifter, coupled to the first shift register and the second shift register, for translating the plurality of first scan signals and the plurality of second scan signals to generate a plurality of first output signals and a plurality of second output signals respectively; a logic processing unit, coupled to the level shifter, for selectively performing a logic operation process on the plurality of first output signals and the plurality of second output signals to generate a plurality of gate driving signals; an output stage, coupled to the logic processing unit and a plurality of scan lines, for outputting the plurality of gate driving signals to a plurality of scan lines correspondingly.

The present invention further discloses a driving method, which the driving method includes providing a synchronization start signal and a clock signal; sequentially generating a plurality of first scan signals according to the synchronization start signal and the clock signal; generating an enable signal according to the plurality of first scan signals; sequentially generating a plurality of second scan signals according to the synchronization start signal, the clock signal, and the enable signal; translating the plurality of first scan signals and the plurality of second scan signals to generate a plurality of first output signals and a plurality of second output signals; selectively performing a logic operation process on the plurality of first output signals and the plurality of second output signals to generate a plurality of gate driving signals; and outputting the plurality of gate driving signals to a plurality of scan lines correspondingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a gate driver according to the prior art.

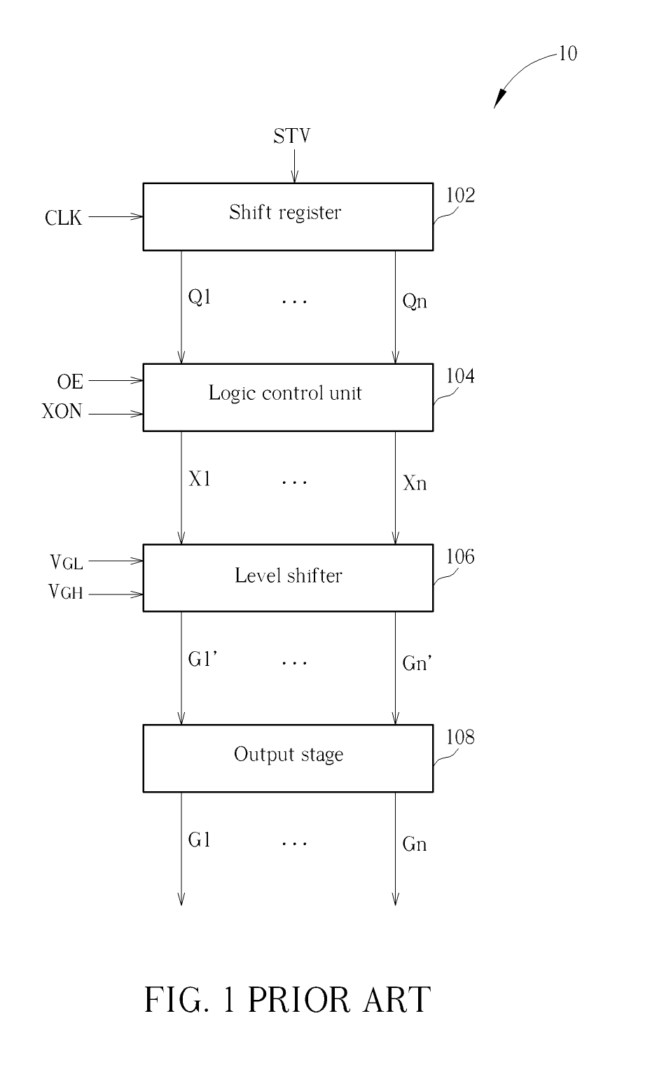

FIG. 2 is a schematic diagram of the gate driver using single start pulse driving according to the prior art.

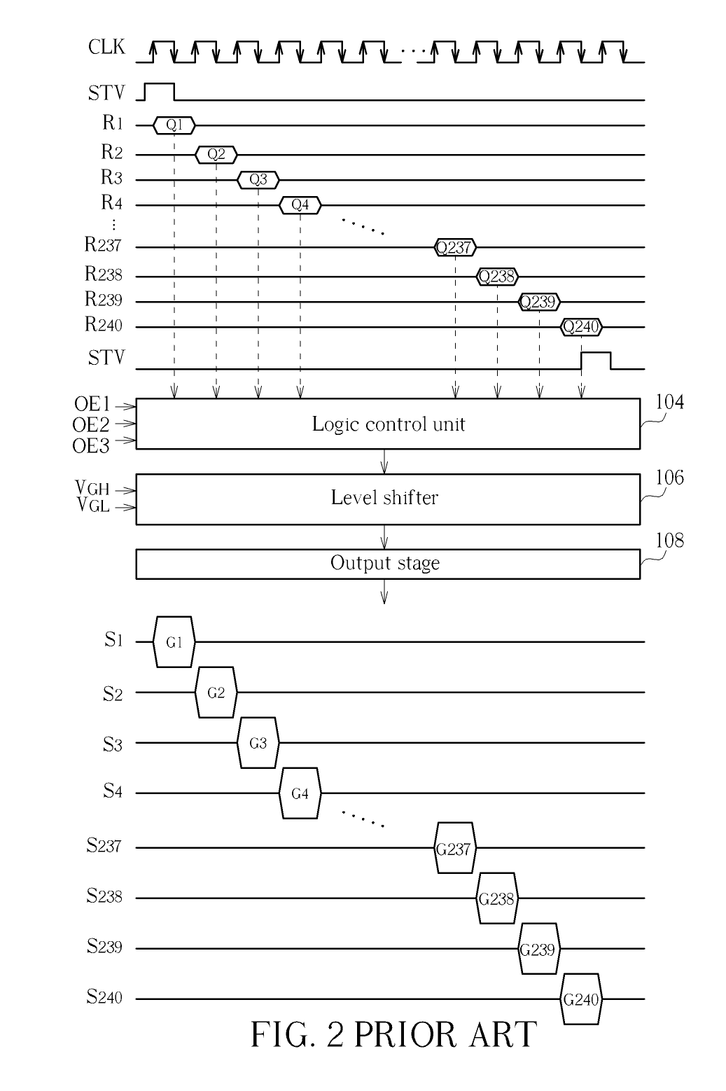

FIG. 3 is a schematic diagram of the gate driver using long start pulse driving according to the prior art.

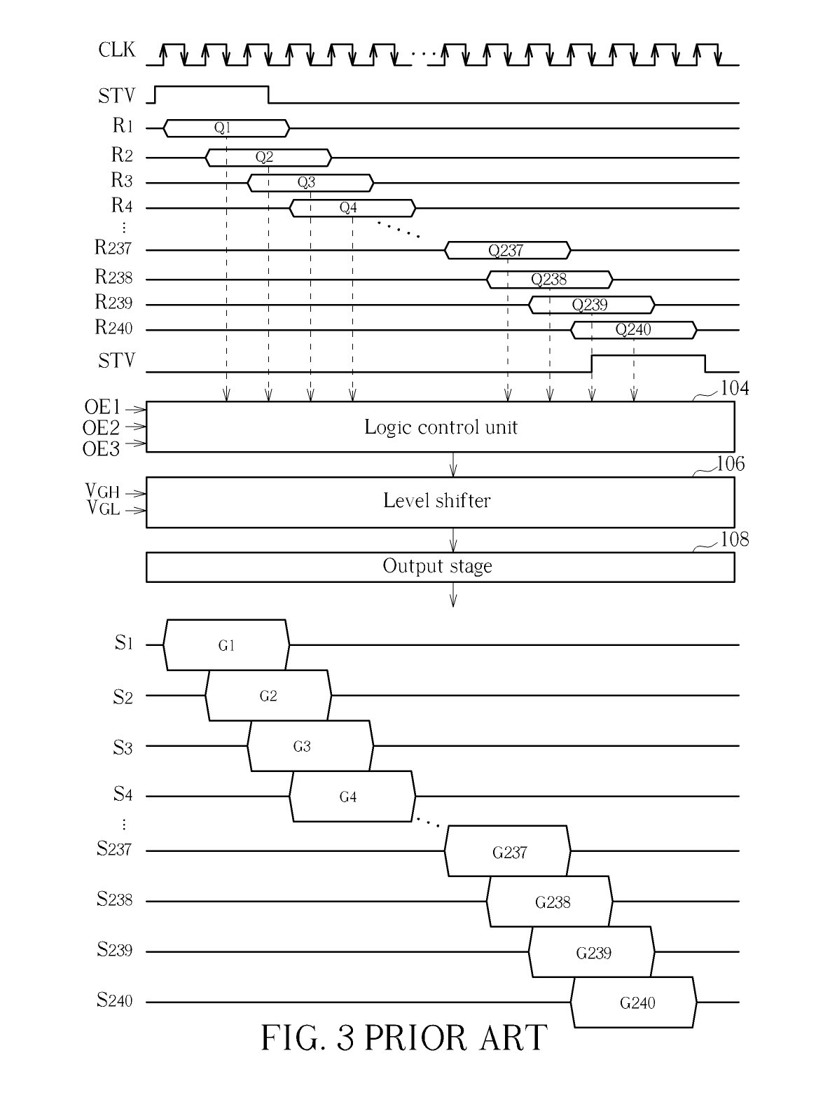

FIG. 4 is a schematic diagram of the gate driver using dual start pulse driving according to the prior art.

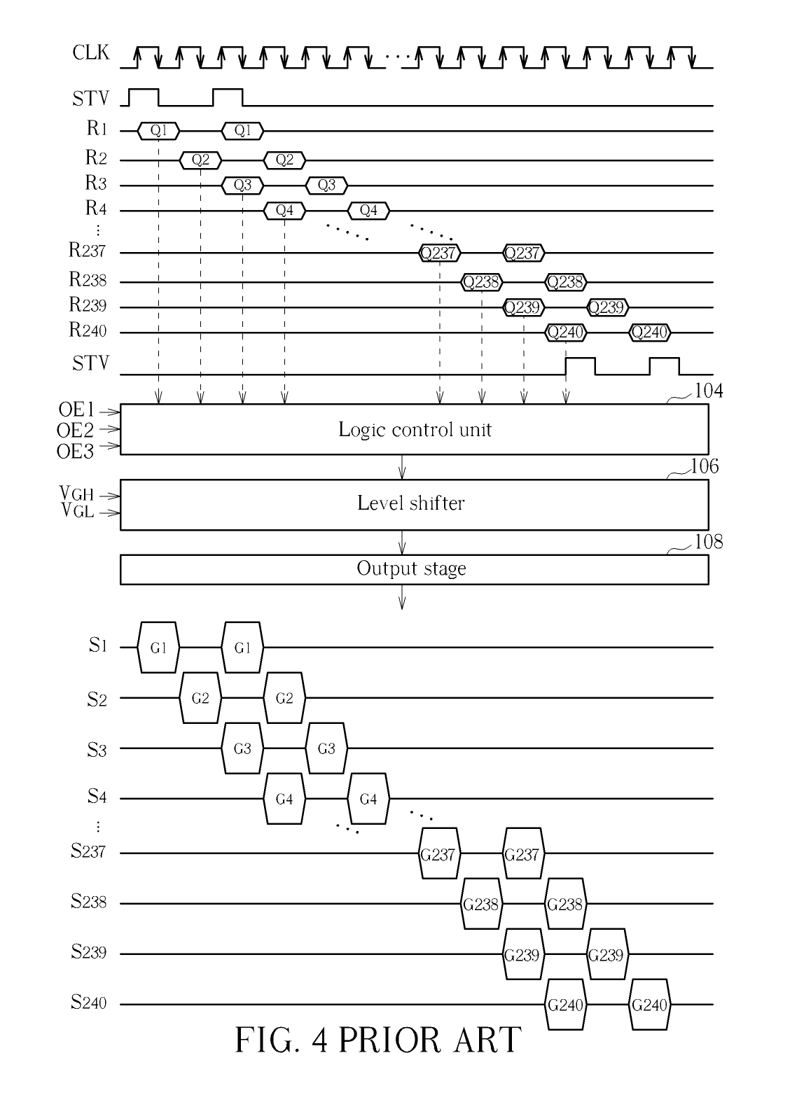

FIG. 5 is a schematic diagram of a gate driver according to the prior art.

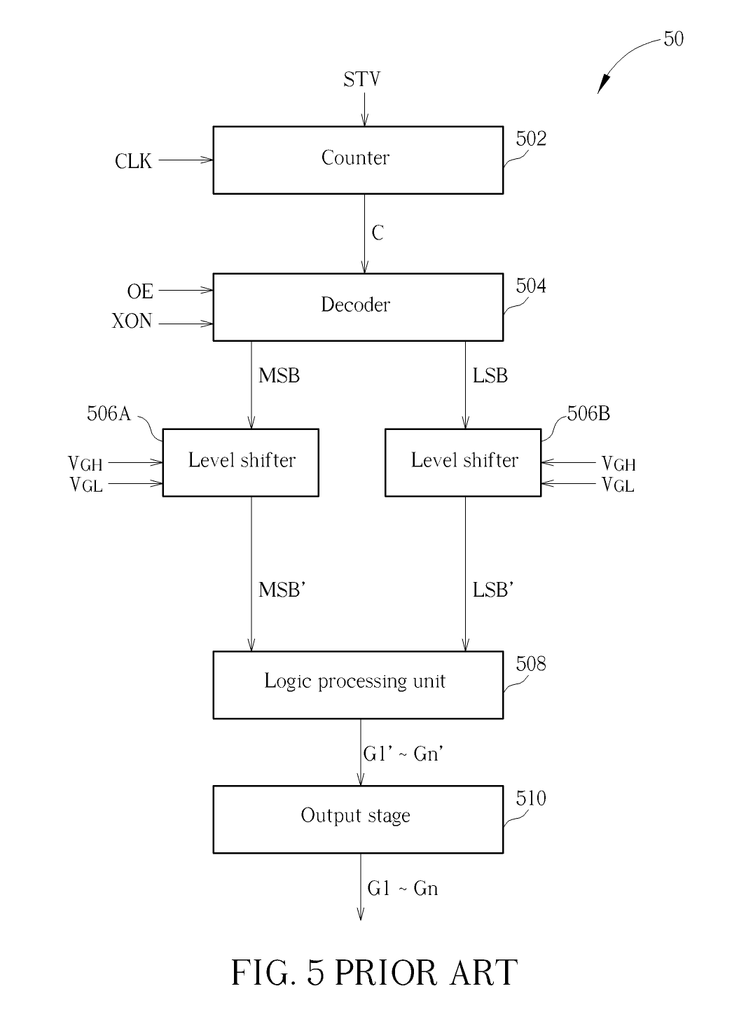

FIG. 6 is a schematic diagram of the gate driver using single start pulse driving shown in FIG. 5 according to the prior art.

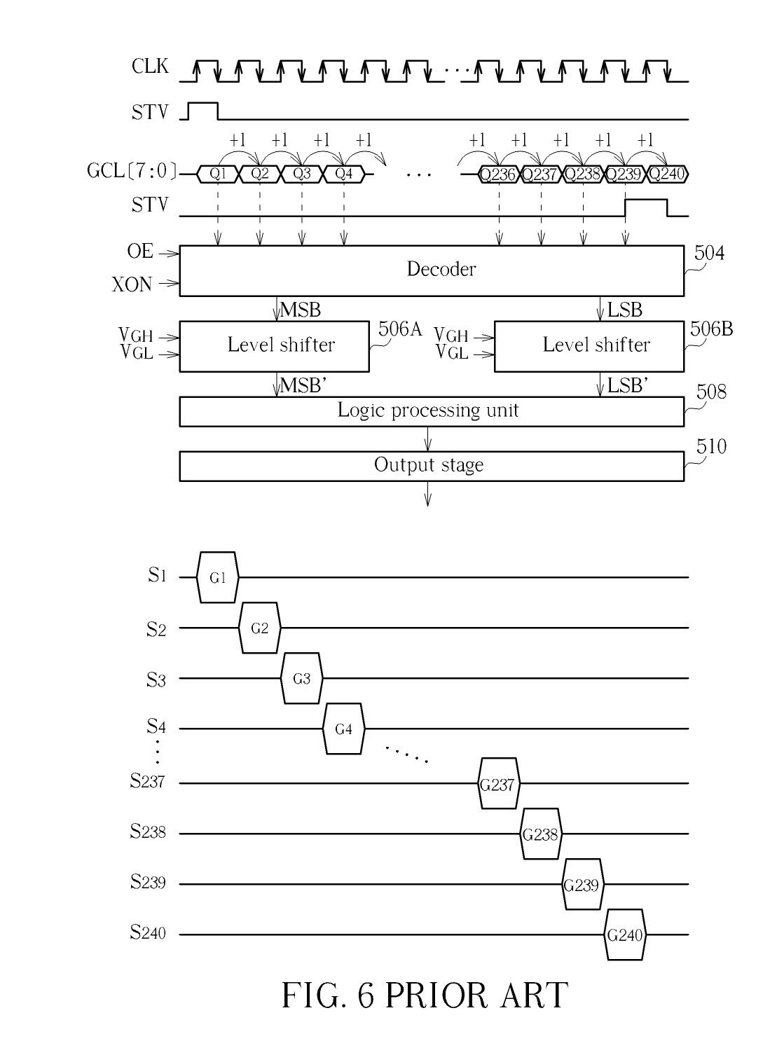

FIG. 7 is a schematic diagram of a gate driver according to an embodiment of the present invention.

FIG. 8 is a schematic diagram of the first shift register shown in FIG. 7.

FIG. 9 is a schematic diagram of the second shift register shown in FIG. 7.

FIG. 10 is an operation state diagram of the gate driver shown in FIG. 7.

FIG. 11 is a schematic diagram of related signals of the gate driver having 240 output channels and using single start pulse driving shown in FIG. 7 according to an embodiment of the present invention.

FIG. 12 is a timing diagram of related signals of the gate driver having 240 output channels and using single start pulse driving shown in FIG. 7 according to an embodiment of the present invention.

FIG. 13 is a schematic diagram of related signals of the gate driver having 240 output channels and using long start pulse driving shown in FIG. 7 according to an embodiment of the present invention.

FIG. 14 is a timing diagram of related signals of the gate driver having 240 output channels and using long start pulse driving shown in FIG. 7 according to an embodiment of the present invention.

FIG. 15 is a schematic diagram of related signals of the gate driver having 240 output channels and using dual start pulse driving shown in FIG. 7 according to an embodiment of the present invention.

FIG. 16 is a timing diagram of related signals of the gate driver having 240 output channels and using dual start pulse driving shown in FIG. 7 according to an embodiment of the present invention.

FIG. 17 is a procedure according to an embodiment of the invention.

### DETAILED DESCRIPTION

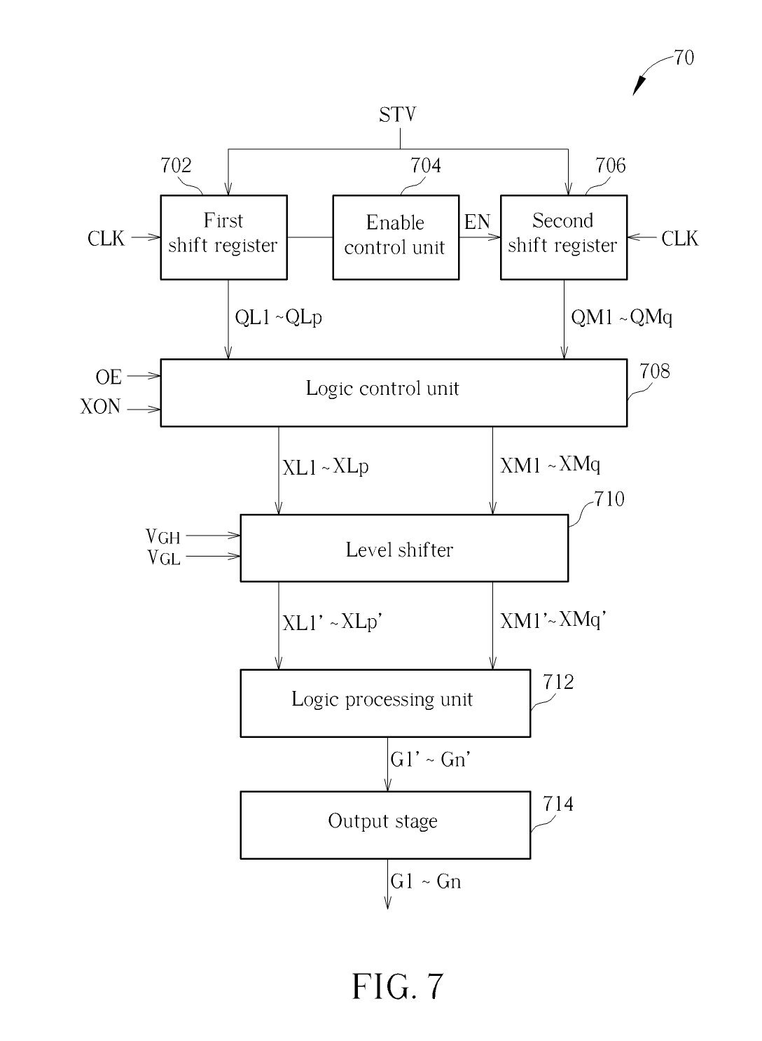

Please refer to FIG. 7, which is a schematic diagram of a gate driver 70 according to an embodiment of the present invention. The gate driver 70 is utilized for driving an LCD panel through generating gate driving signals G1 to Gn outputted to corresponding scan lines S1 to Sn according to a synchronization start signal STV and a clock signal CLK. In detail, the gate driver 70 includes a first shift register 702, an enable control unit 704, a second shift register 706, a logic control unit 708, a level shifter 710, a logic processing unit 712 and an output stage 714. The first shift register 702 is utilized for sequentially generating first scan signals QL1 to QLp according to the synchronization start signal STV and the clock signal CLK. The enable control unit 704 is coupled to the first shift register 702 and the second shift register 706 for generating an enable signal EN according to the first scan signals QL1 to QLp. The second shift register 706 is coupled to the enable control unit 704 for sequentially generating second scan signals QM1 to QMq according to the synchronization start signal STV, the clock signal CLK, and the enable signal EN. The logic control unit 708 is coupled to the first shift register 702 and the second shift register 706 for translating the first scan signals QL1 to QLp into first logic control signals XL1 to XLp according to a control signal, translating the second scan signals QM1 to QMq into second logic control signals XM1 to XMq according to the control signal, and transmitting the first logic control signals XL1 to XLp and the second logic control signals XM1 to XMq to the level shifter 710. The level shifter 710 is coupled to the logic processing unit 708 for translating voltage level of the first logic control signals XL1 to XLp to generate first output signals XL1′ to XLp′, and translating voltage level of the second logic control signals XM1 to XMq to generate second output signals XM1′ to XMq′. The logic processing unit 712 is coupled to the level shifter 710 for selectively performing a logic operation process on the first output signals XL1′ to XLp′ and the second output signals XM1′ to XMq′ to generate gate driving signals G1′ to Gn′. The output stage 714 is coupled to the logic processing unit 712 and the scan lines S1 to Sn for outputting the gate driving signals G1 to Gn to the scan lines S1 to Sn correspondingly to drive each pixel unit of the LCD for realizing image display.

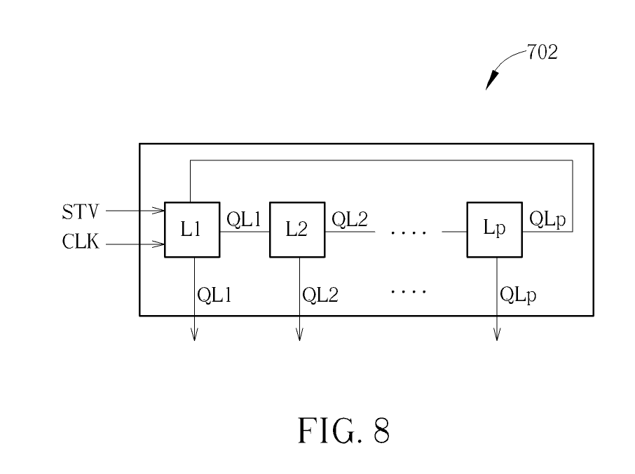

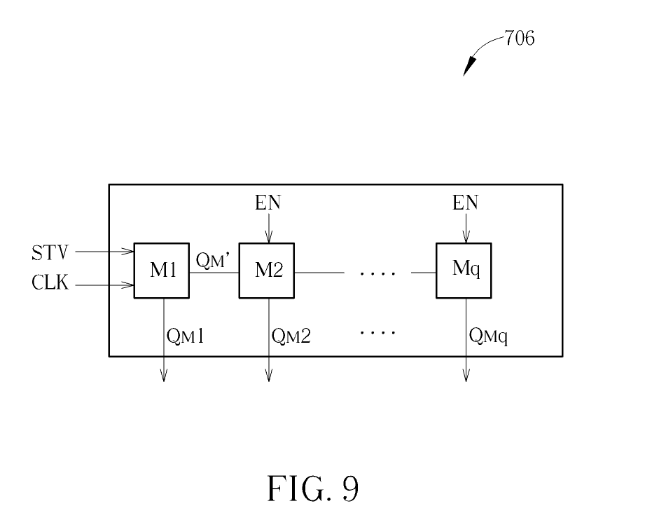

FIG. 8 and FIG. 9 are schematic diagrams of the first shift register 702 and the second shift register 706 shown in FIG. 7. The first shift register 702 includes first shift register units L1 to Lp. The second shift register 706 includes second shift register units M1 to Mp. When the synchronization start signal STV is provided to the gate driver 70, the synchronization start signal STV is capable of being delivered to the first shift register 702 and the second shift register 706 simultaneously. As the first shift register 702 and the second shift register 706 receive the synchronization start signal STV, each begins to perform related operation processes accordingly.

As shown in FIG. 8, the first shift register unit L1 of the first shift register 702 generates a first scan signal QL1 according to the clock signal CLK (when a clock rising edge trigger occurs) after the first shift register unit L1 receives the synchronization start signal STV. Furthermore, the first shift register unit L1 transmits the first scan signal QL1 to the logic control unit 708, and also delivers the first scan signal QL1 to the next stage (the first shift register unit L2) as a start signal, simultaneously. Similarly, regarding the first shift register unit L2 of the first shift register 702, the first shift register unit L2 generates a first scan signal QL2 according to the clock signal CLK after receiving the first scan signal QL1, and in such manner, the first shift register units L1 to Lp can generate the first scan signals QL1 to QLp sequentially. Note that, in the first shift register 702, the first shift register unit Lp is coupled to the first shift register unit L1 so that the first scan signal QLp generated by the first shift register unit Lp is transmitted to the first shift register unit L1 for a next cycle. In such a condition, the first shift register unit L1 starts to generate the first scan signal QL1 again according to the clock signal CLK and the first scan signal QLp. In other words, the first shift register 702 can generate the first scan signals QL1 to QLp repeatedly for the following processes. Moreover, at the first operation cycle, the first shift register unit L1 can generate the first scan signal QL1 according to the synchronization start signal STV, and at the following operation cycle, the first shift register unit L1 can generate the first scan signal QL1 according to the first scan signal QLp generated by the first shift register unit Lp. Besides, number of operation cycles of regenerating the first scan signal by the first shift register 702 depends on the number of output channels of the gate driver 70.

As shown in FIG. 9, the second shift register units M1 of the second shift register 706 generate a second scan signal QM1 according to the clock signal CLK and the synchronization start signal STV after receiving the synchronization start signal STV. Furthermore, the second shift register unit M1 transmits the second scan signal QM1 to the logic control unit 708, and also delivers the second scan signal QM1 to the next stage (the second shift register unit M2) simultaneously. Different from the first shift register 702, the second shift register unit M1 of the second shift register 706 can generate a second scan signal QM1 after receiving the synchronization start signal STV, and in the following second shift register units M2 to Mq, each second shift register unit enables the next second shift register unit to generate the corresponding second scan signal after the enable signal EN provided by the enable control unit 704 is received. That is, after the second shift register unit M2 receives the enable signal EN, the second shift register unit M2 further generates the second scan signal QM2 according to the clock signal CLK. In this manner, the second shift register units M1 to Mq can generate the second scan signals QM1 to QMq sequentially according to the synchronization start signal STV and the clock signal CLK through the control of the enable control unit 704.

On the other hand, the enable control unit 704 generates the enable signal EN according to the scan signal generation state of the first shift register 702. For example, the enable control unit 704 can be set to generate the enable signal EN after the first shift register 702 has generated a specific number of first scan signals sequentially. For example, the second shift register unit M1 can generate the second scan signal QM1 according to the synchronization start signal STV after receiving the synchronization start signal STV. Furthermore, after the first shift register 702 generates first scan signals QL1 to QL4 sequentially, the enable control unit 704 can generate the enable signal EN outputted to the second shift register 706 to enable the next second shift register unit (second shift register unit M2) for generating the corresponding second scan signal QM2. Thus, after the first shift register 702 generates first scan signals QL5 to QL8 sequentially, the enable control unit 704 can further generate the enable signal EN outputted to the second shift register 706 to enable the next second shift register unit (second shift register unit M3) for generating the corresponding second scan signal QM3.

Moreover, the first scan signals QL1 to QLp generated by the first shift register 702 can be processed by the logic control unit 708 and the level shifter 710 to be translated to the corresponding high voltage signal (i.e. first output signals XL1′ to XLp). Similarly, the second scan signals QM1 to QMq generated by the second shift register 706 can be translated to the corresponding high voltage signal (second output signals XM1′ to XMq′). The logic processing unit 712 can selectively perform a logic operation process on the first output signals XL1′ to XLp′ and the second output signals XM1′ to XMq′ to generate gate driving signals G1′ to Gn′. For example, the logic processing unit 712 can perform a logic operation process on each of the second output signals and the first output signals generated during a specific clock period. and generate the corresponding gate driving signals G1′ to Gn′ according to the gate driving signals G1′ to Gn′.

In brief, the present invention divides the shift register into the first shift register 702 and the second shift register 704, and performs logic operations on the signals corresponding to the first shift register 702 and the second shift register 706 for generating corresponding gate driving signals. As a result, number of shift register units utilized in the first shift register 702 and the second shift register will be far less than the number of output channels required for the gate driver. Therefore, compared with the conventional gate driver, the gate driver 70 of the invention can decrease the number of shift registers required substantially, and number of high voltage circuit components (e.g. level shifter 710) is comparatively decreased substantially. In other words, the present invention can reduce circuit area and manufacturing cost effectively, and more importantly, the gate driver 70 of the present invention is capable of being adapted to the long start pulse driving and dual start pulse driving application, so that the gate driver 70 can also realize various image enhancement functions through adopting the long start pulse driving (or dual start pulse driving) with various logic control signals.

Besides, the logic control unit 708 is able to process signals generated by each shift register according to related control signals provided by the timing controller, such as an output enabled signal OE, a global on indication signal XON, etc., for implementing related image display enhancement or adjustment functions. If the gate driver 70 does not need to implement any related image enhancement or adjustment functions, the logic control unit 708 can be omitted without influencing the whole operation.

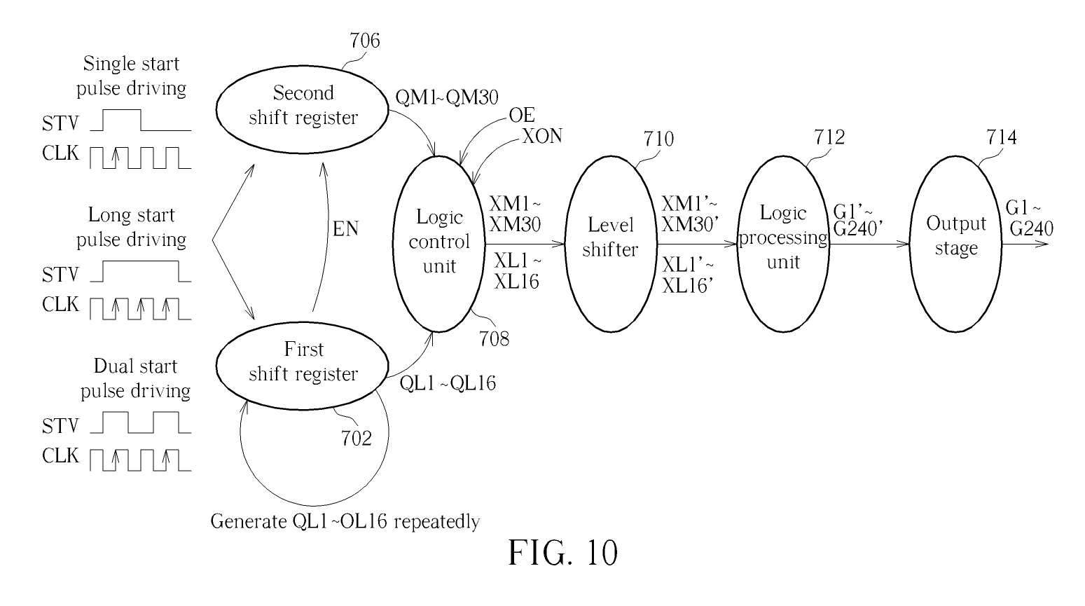

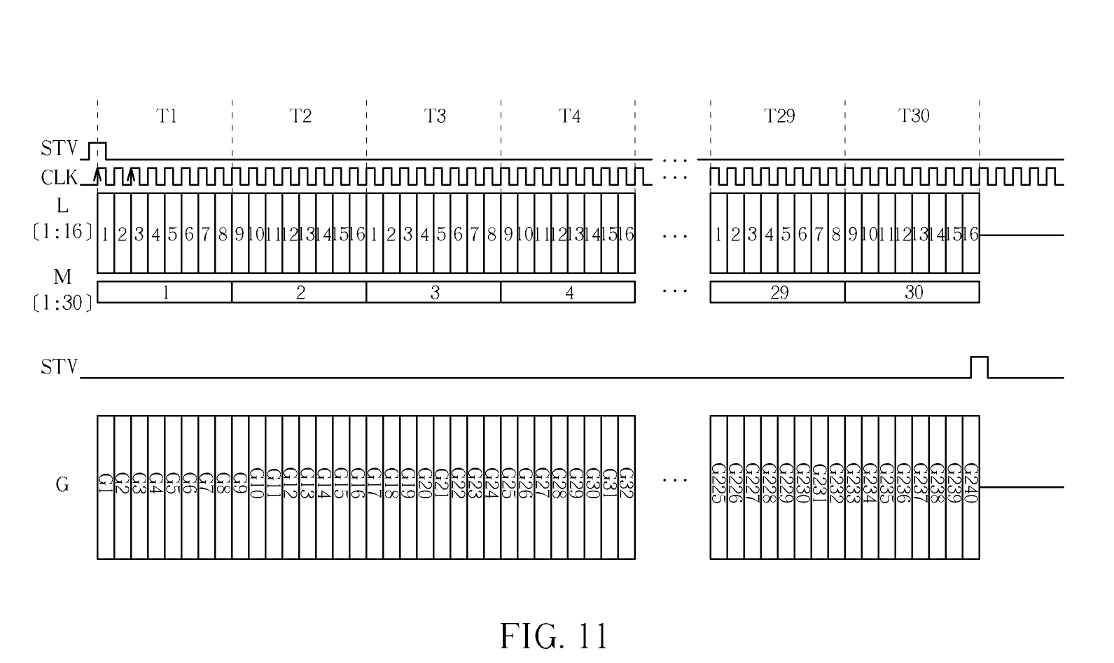

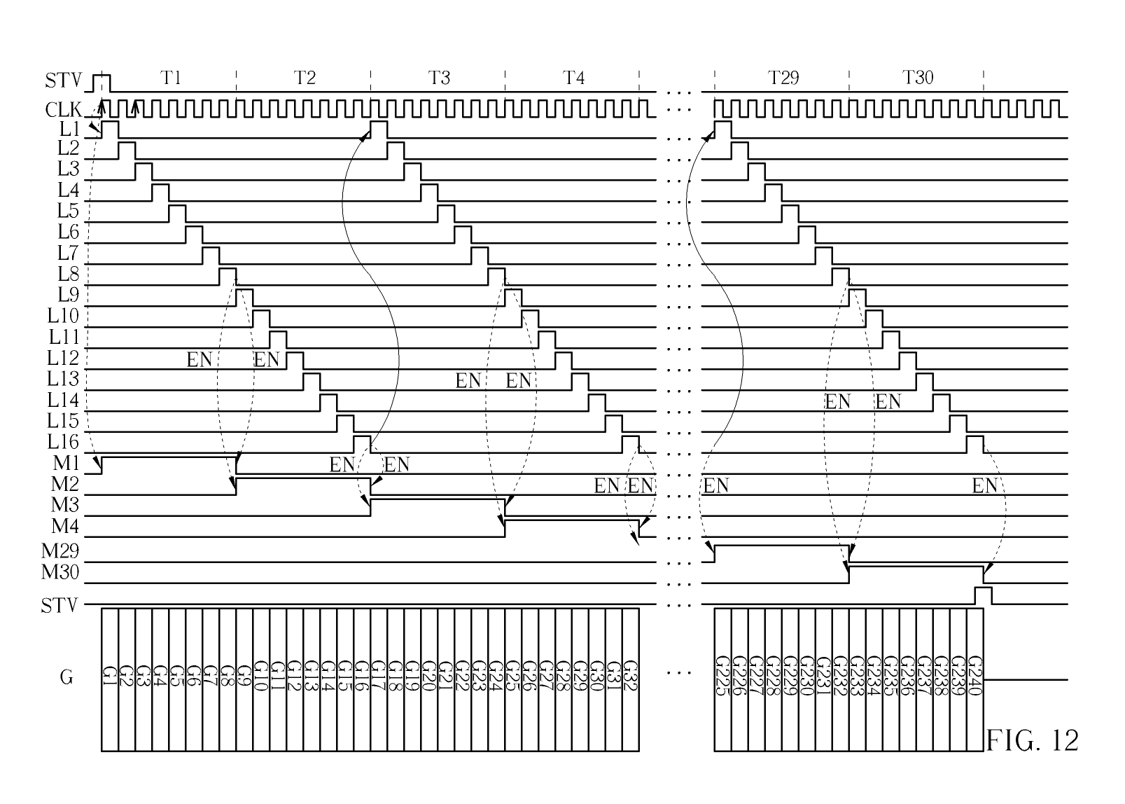

For brevity of description, suppose the gate driver 70 includes 240 output channels (n=240). In such a situation, if the image resolution of the LCD is 640 (horizontal resolution) by 480 (vertical resolution) pixels, two of the gate drivers 70 having 240 output channels can be arranged in serial connected to implement the gate driving control of the LCD for image display. Please refer to FIG. 10 to FIG. 12. FIG. 10 is an operation state diagram of the gate driver 70 shown in FIG. 7. FIG. 11 is a schematic diagram of related signals of the gate driver 70 having 240 output channels and using single start pulse driving shown in FIG. 7 according to an embodiment of the present invention. FIG. 12 is a timing diagram of related signals of the gate driver 70 having 240 output channels and using single start pulse driving shown in FIG. 7 according to an embodiment of the present invention. In the embodiment, suppose the first shift register 702 and the second shift register 706 utilize the clock rising edge trigger, the first shift register 702 includes first shift register units L1 to L16, and the second shift register 706 includes second shift register units M1 to M30. First, the first shift register unit L1 (the first stage) of the first shift register 702 and the second shift register unit M1 (the first stage) of the second shift register 706 can receive the synchronization start signal STV. After that, the first shift register 702 utilizes the first shift register unit L1 to generate the first scan signal QL1 through the rising edge trigger of the synchronization start signal STV, and therefore generates first scan signals QL2 to QLp sequentially according to the mentioned operation principle and re-generates the first scan signals QL1 to QL16 repeatedly. In the second shift register 706, the second shift register unit M1 can generate the second scan signal QM1 according to the clock signal CLK and the synchronization start signal STV after receiving the synchronization start signal STV, and wait for the enable signal EN. After the enable signal EN is received, the next stage (the second shift register unit M2) is enabled to generate the second scan signal QM2. In this manner, the second shift register units M2 to M30 generate the second scan signals QM2 to QM30 sequentially. Furthermore, the logic control unit 708 translates the first scan signals QL1 to QL16 into first logic control signals XL1 to XL16, and translates the second scan signals QM1 to QM30 into second logic control signals XM1 to XM30, respectively, according to the output enabled signal OE and the global on indication signal XON. Through the voltage level translating process of the level shifter 710, the first logic control signals XL1 to XL16 can be translated to first output signals XL1′ to XL16′, and the second logic control signals XM1 to XM30 can be translated to second output signals XM1′ to XM30′. The logic processing unit 712 can selectively perform logic operation processes on the first output signals XL1′ to XL16′ and the second output signals XM1′ to XM30′ to generate gate driving signals G1′ to G240′. Finally, according to the gate driving signals G1′ to G240′, the output stage 714 can output the gate driving signals G1 to G240 to drive each pixel unit of the LCD for realizing image display.

As shown in FIG. 11 and FIG. 12, a single pulse driving method is adopted. Suppose the enable control unit 704 can generate the enable signal EN to enable the next second shift register unit to generate the corresponding second scan signal after every eight scan signals is generated. In FIG. 11, L[1:16] represents scan signals generated by the first shift register 702, and M[1:30] represents scan signals generated by the second shift register 706. The number in the square bracket represents the scan signal generated by the corresponding shift register unit. For example, the number ‘8’ in [1:16] indicates the first scan signal QL8 generated by the first shift register unit L8. The gate driving signal G represents the gate driving signals G1 to G240 outputted to each scan line by the output stage 714. Because the first output signals XL1′ to XL16′ correspond to the first scan signals QL1 to QL16 respectively, and the second output signals XM1′ to XM30′ correspond to the second scan signals QM1 to QM30 respectively, the logic processing unit 712 can select corresponding signals from the first output signals XL1′ to XL16′ and the second output signals XM1′ to XM30′ according to the corresponding relationship shown in FIG. 11 for performing logic operation processes to generate the gate driving signals G1′ to G240′. For example, as shown in FIG. 11, the gate driving signals G1 to G8 correspond to M[1] and L[1:8], so that the logic processing unit 712 can perform logic operation processes on the second output signal XM1′ (corresponding to the second scan signal QM1 generated by the second shift register unit M1) and the first output signals XL1′ to XL8′ (corresponding to the first scan signals QL1 to QL8 generated by the first shift register units L1 to L8) during the clock period T1, and therefore generate the gate driving signals G1′ to G8′, accordingly. The gate driving signals G9 to G16 correspond to M [2] and L [9:16], so that the logic processing unit 712 can perform logic operations on the second output signal XM2′ (corresponding to the second scan signal QM2 generated by the second shift register unit M2) and the first output signals XL9′ to XL16′ (corresponding to the first scan signals QL9 to QL16 generated by the first shift register units L9 to L16) during the clock period T2, and generate the gate driving signals G9′ to G16′, accordingly. In this manner, the gate driving signals G1′ to G240′ are generated sequentially. In addition, as shown in FIG. 12, the first shift register 702 can generate the first scan signals QL1 to QL16 repeatedly, and the enable control unit 704 can generate the enable signal EN to enable the next second shift register unit to generate the next second scan signal after every eight scan signals is generated. However, the corresponding relationship shown in FIG. 11 and FIG. 12 arranged for the logic processing unit 712 (when using sixteen first shift register units (L1 to L16) and thirty second shift register units (M1 to M30)) is only an embodiment of the invention, and this should not be a limitation, as any other corresponding method is available in other embodiments. Moreover, any number of the first shift register units or any number of the second shift register units is suitable, as long as number of gate driving signals processed by the logic processing unit 712 satisfies design requirements.

As can been seen, the gate driver 70 providing 240 output channels needs less circuit area (only using forty-six sets of shift registers) in the low voltage circuit block and also less circuit area (only using forty-six sets of level shifters) in the high voltage block, which is far less than the requirement of the gate driver 10. On the whole, compared with the gate driver 10 of the prior art, the gate driver 70 of the present invention can reduce the required number of high voltage circuit components substantially. For example, the number of the required shift registers is decreased from two hundred and forty sets to forty-six sets, which may reduce circuit area by about 30% to 40%. Compared with the gate driver 50 of the prior art, the gate driver 70 of the present invention has a similar circuit area reduction capability with the gate driver 50, but the gate driver 70 can further support the long start pulse driving application and the dual start pulse driving application. In other words, the present invention can further be suited to other gate driving applications having image display enhancement functions.

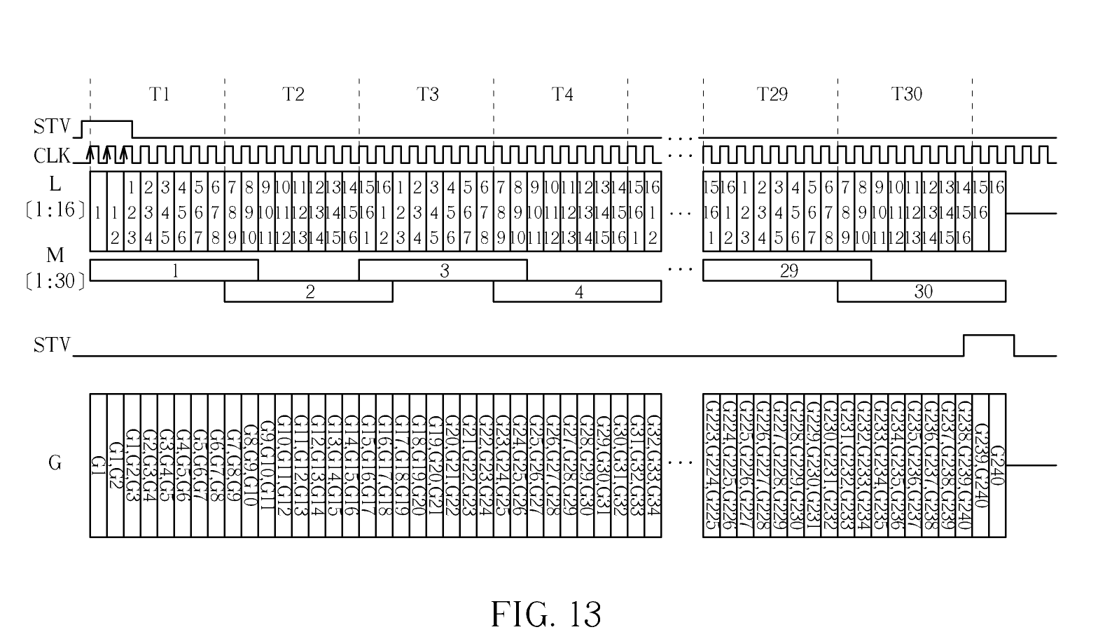

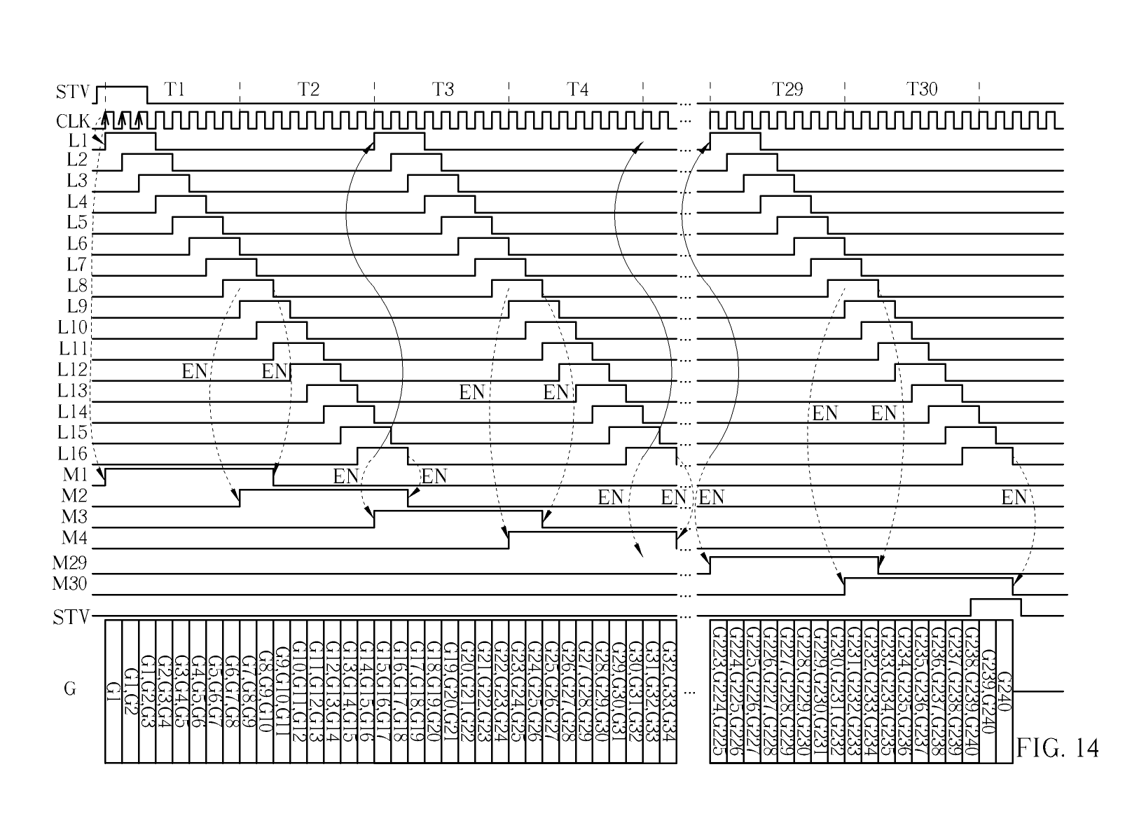

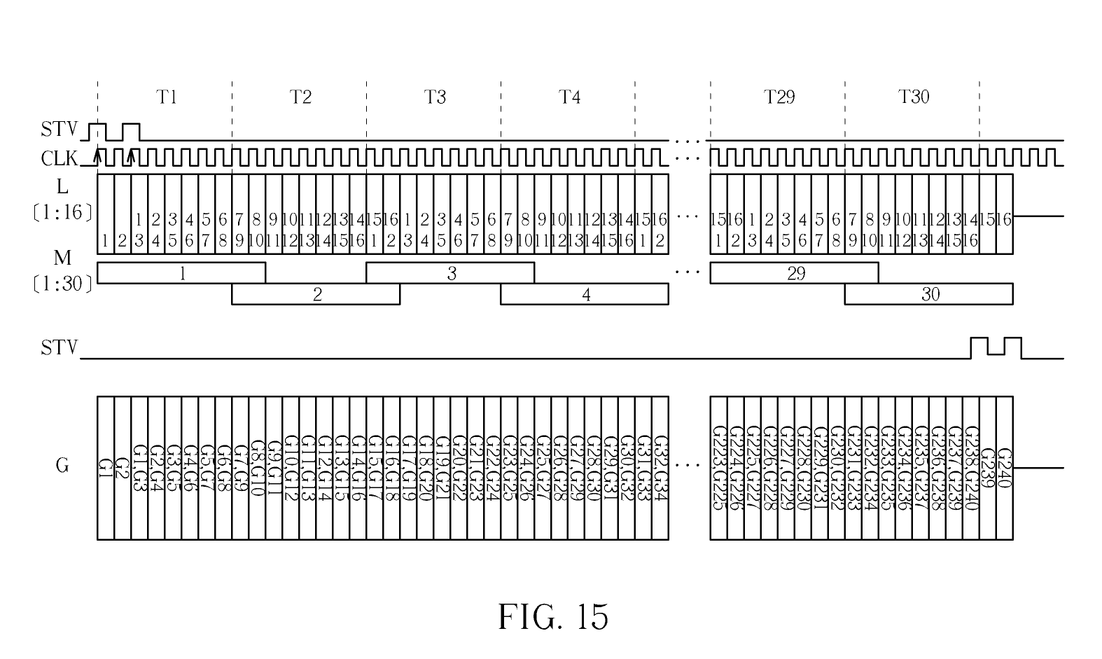

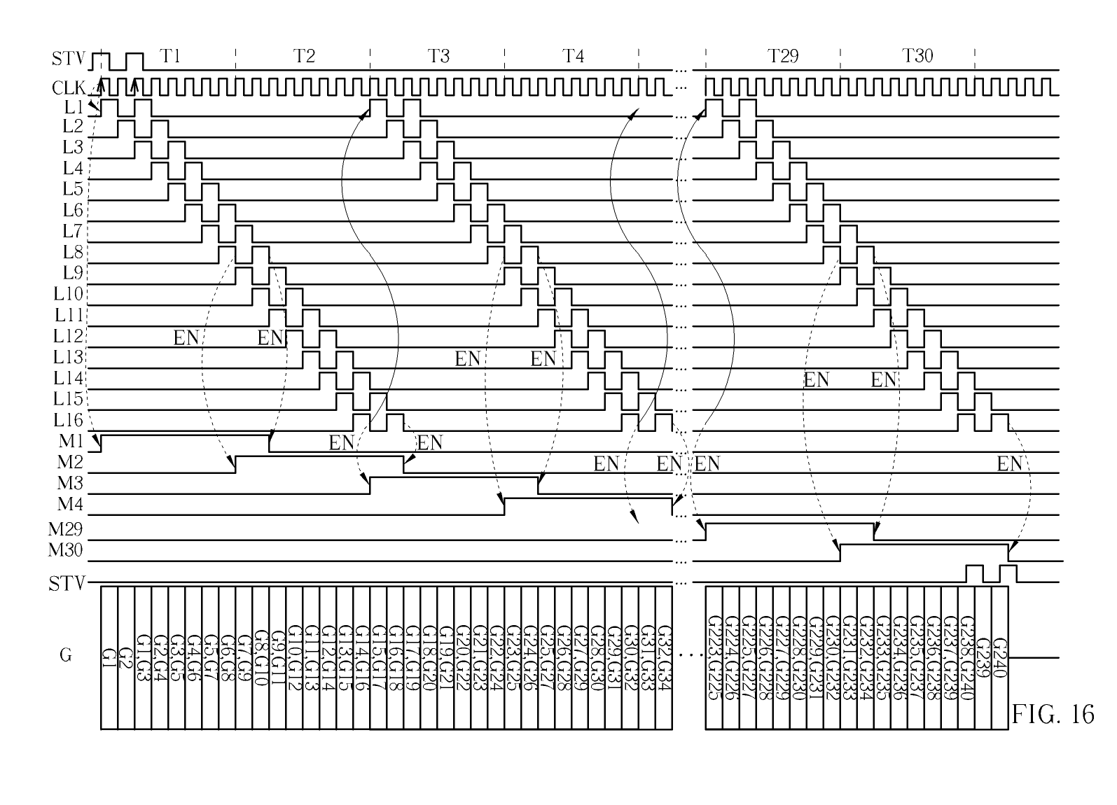

Moreover, the present invention can also be applied in the gate driver using dual start pulse driving or long start pulse driving. Please refer to FIG. 13 to FIG. 16. FIG. 13 and FIG. 14 are a schematic diagram and a timing diagram of related signals of the gate driver 70 having 240 output channels and using long start pulse driving shown in FIG. 7 according to an embodiment of the present invention, respectively. FIG. 15 and FIG. 16 are a schematic diagram and a timing diagram of related signals of the gate driver 70 having 240 output channels and using dual start pulse driving shown in FIG. 7 according to an embodiment of the present invention, respectively. Compared with FIG. 11 and FIG. 12, the difference of the gate driver 70 shown in FIG. 13 to FIG. 16 is only the driving method of the shift register, and other operation principles are similar to the gate driver 70 shown in FIG. 11 and FIG. 12, thus further description is omitted for brevity.

Note that, the gate driver 70 is an exemplary embodiment of the present invention, and those skilled in the art can make alternations and modifications accordingly. For example, the shift register is triggered in accordance with the rising edge trigger of the clock signal CLK, and this should not be a limitation of the present invention. Any type of trigger condition, such as the rising edge trigger or other different trigger types, is suitable. The number of operation cycles of re-generating the first scan signals by the first shift register 702 depends on the number of output channels of the gate driver 70, which means any configuration of the corresponding first scan signals that can offer the logic processing unit 712 sufficient information to generate the corresponding gate driving signal for the whole output channel is suitable. In addition, the logic operation performed by the logic processing unit 712 can be a NAND logic operation process, a NOR logic operation process, or any other Boolean logic operation process.

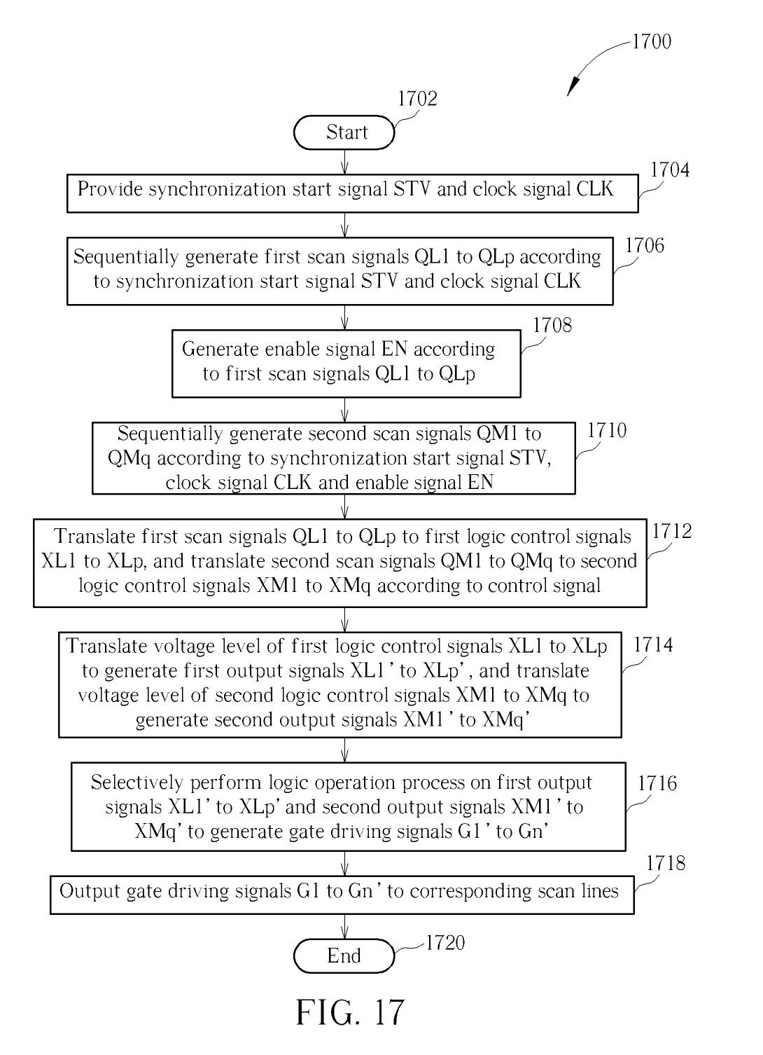

As to the implementation of the gate driver 70, please refer to FIG. 17. FIG. 17 is a procedure 1700 according to an embodiment of the invention. The procedure 1700 is only an embodiment for implementing the gate driver 70, and is not a limitation of the present invention. Note that, if the result are substantially the same, the steps are not limited to be executed according to the exact order shown in FIG. 17, other steps can also be added to the procedure 1700, and part of the steps of the procedure 1700 can be removed without departing from the spirit of the present invention. The procedure 1700 includes the following steps:

Step 1702: Start.

Step 1704: Provide synchronization start signal STV and clock signal CLK.

Step 1706: Sequentially generate first scan signals QL1 to QLp according to synchronization start signal STV and clock signal CLK.

Step 1708: Generate enable signal EN according to first scan signals QL1 to QLp.

Step 1710: Sequentially generate second scan signals QM1 to QMq according to synchronization start signal STV, clock signal CLK and enable signal EN.

Step 1712: Translate first scan signals QL1 to QLp to first logic control signals XL1 to XLp, and translate second scan signals QM1 to QMq to second logic control signals XM1 to XMq according to control signal.

Step 1714: Translate voltage level of first logic control signals XL1 to XLp to generate first output signals XL1′ to XLp′, and translate voltage level of second logic control signals XM1 to XMq to generate second output signals XM1′ to XMq′.

Step 1716: Selectively perform logic operation process on first output signals XL1′ to XLp′ and second output signals XM1′ to XMq′ to generate gate driving signals G1′ to Gn′.

Step 1718: Output gate driving signals G1 to Gn to corresponding scan lines.

Step 1720: End.

The procedure 1700 is utilized for illustrating the implementation of the gate driver 70. Related variations and the detailed description can be referred from the foregoing description, so as not to be narrated herein.

In summary, the present invention divides the shift register into the first shift register 702 and the second shift register 704, and performs logic operation on the signals corresponding to the first shift register 702 and the second shift register 706 for generating corresponding gate driving signals. As a result, the present invention can reduce number of the required high voltage circuit component substantially, reducing circuit area and manufacturing cost effectively, and more importantly, the present invention is capable of being adapted to single start pulse driving, long start pulse driving and dual start pulse driving applications for realizing more image enhancement functions.

Those skilled in the art will readily observe that numerous modifications and alterations of the device and method may be made while retaining the teachings of the invention.

What is claimed is:

1. A gate driver for a liquid crystal display, comprising:
a first shift register, for sequentially generating a plurality of first scan signals according to a synchronization start signal and a clock signal;
an enable control unit, coupled to the first shift register, for generating an enable signal according to the plurality of first scan signals;
a second shift register, coupled to the enable control unit, for sequentially generating a plurality of second scan signals according to the synchronization start signal, the clock signal, and the enable signal;
a level shifter, coupled to the first shift register and the second shift register, for translating the plurality of first scan signals and the plurality of second scan signals to generate a plurality of first output signals and a plurality of second output signals respectively;
a logic processing unit, coupled to the level shifter, for selectively performing a logic operation process on the plurality of first output signals and the plurality of second output signals to generate a plurality of gate driving signals;
an output stage, coupled to the logic processing unit and a plurality of scan lines, for outputting the plurality of gate driving signals to the plurality of scan lines correspondingly.

2. The gate driver of claim 1, wherein the first shift register comprises a plurality of first shift register units, and the last of the plurality of first shift register units is coupled to the first of the plurality of first shift register units.

3. The gate driver of claim 2, wherein the last of the plurality of first shift register units generates the corresponding first scan signal which is transmitted to the first of the plurality of first shift register units for re-generating the plurality of first scan signals.

4. The gate driver of claim 1, wherein the second shift register comprises a plurality of second shift register units and the first of the plurality of second shift register units generates the corresponding second scan signal according to the synchronization start signal and the clock signal.

5. The gate driver of claim 4, wherein the enable control unit generates the enable signal outputted to the second shift register to enable the next second shift register unit to generate the corresponding second scan signal after the first shift register has generated a first number of first scan signals.

6. The gate driver of claim 1, wherein the synchronization start signal and the clock signal are provided by a timing controller.

7. The gate driver of claim 1, wherein the plurality of gate driving signals are utilized for driving pixel units of each of the plurality of scan lines of the liquid crystal display for display.

8. The gate driver of claim 1 further comprising:
a logic control unit, coupled to the first shift register, the second shift register, and the level shifter, for translating the plurality of first scan signals into a plurality of first logic control signals according to a control signal, translating the plurality of second scan signals into a plurality of second logic control signals according to the control signal, and transmitting the plurality of first logic control signals and the plurality of second logic control signals to the level shifter respectively so that the level shifter translates the plurality of first logic control signals and the plurality of second logic control signals to generate the plurality of first output signals and the plurality of second output signals.

9. The gate driver of claim 8, wherein the control signal comprises an output enabled signal and a global on indication signal.

10. The gate driver of claim 9, wherein the output enabled signal and the global on indication signal are provided by a timing controller.

11. A driving method, comprising:
providing a synchronization start signal and a clock signal;
sequentially generating a plurality of first scan signals according to the synchronization start signal and the clock signal;
generating an enable signal according to the plurality of first scan signals;
sequentially generating a plurality of second scan signals according to the synchronization start signal, the clock signal, and the enable signal;
translating the plurality of first scan signals and the plurality of second scan signals to generate a plurality of first output signals and a plurality of second output signals;
selectively performing a logic operation process on the plurality of first output signals and the plurality of second output signals to generate a plurality of gate driving signals; and
outputting the plurality of gate driving signals to a plurality of scan lines correspondingly.

12. The driving method of claim 11, wherein the step of sequentially generating the plurality of first scan signals according to the synchronization start signal and the clock signal further comprises re-generating the plurality of first scan signals after the plurality of first scan signals are generated.

13. The driving method of claim 11, wherein the step of generating the enable signal according to the plurality of first scan signals is generating the enable signal after the first shift register generates a first amount of first scan signals.

14. The driving method of claim 11, wherein the step of sequentially generating a plurality of second scan signals according to the synchronization start signal, the clock signal, and the enable signal comprises:
generating a second scan signal according to the synchronization start signal and the clock signal after receiving the synchronization start signal and the clock signal; and
sequentially generating other corresponding second scan signals according to the clock signal and the enable signal after receiving the enable signal.

15. The driving method of claim 11, wherein the synchronization start signal and the clock signal are provided by a timing controller.

16. The driving method of claim 11 further comprises:
translating the plurality of first scan signals into a plurality of first logic control signals according to a control signal and translating the plurality of second scan signals into a plurality of second logic control signals according to the control signal; and
translating voltage level of the plurality of first logic control signals and the plurality of second logic control signals to generate the plurality of first output signals and the plurality of second output signals.

17. The driving method of claim 16, wherein the control signal comprises an output enabled signal and a global on indication signal.

18. The driving method of claim 17, wherein the output enabled signal and the global on indication signal are provided by a timing controller.
